(19) United States
(12) Patent Application Publication
(10) Pub. No.: US 2007/0199319 A1
(43) Pub. Date: Aug. 30, 2007

(54) System and method for controlling engine charge air temperature

(76) Inventor: Burnell L. Bender, Woodburn, IN (US)

Correspondence Address: INTERNATIONAL TRUCK INTELLECTUAL PROPERTY COMPANY,, 4201 WINFIELD ROAD, P.O. BOX 1488, WARRENVILLE, IL, 60555, US

(21) Appl. No.: 11/363,605

(22) Filed: Feb. 28, 2006

(51) Int. Cl. F02B 29/04; F02D 23/00; F02B 33/44

(52) U.S. Cl. 60/599; 60/600; 60/605.1

(57) ABSTRACT

A bypass (26) around a charge air cooler (20) and a control system (28) for apportioning the amounts of charge air passing through the bypass and the charge air cooler.

### FIELD OF THE INVENTION

The present invention relates to internal combustion engines in motor vehicles, especially to an engine intake system that delivers charge air and a method for charge air temperature control in a diesel engine.

### BACKGROUND OF THE INVENTION

The diesel engine industry is facing increasingly strict limits on certain undesirable constituents in diesel engine exhaust, such as oxides of nitrogen (NOₓ) and particulate matter (PM) emissions. After-treatment devices such as diesel particulate filters (DPF's) and NOₓ adsorbers are potential solutions for reducing PM and NOₓ emissions by physically trapping them. Alternative diesel combustion processes such as HCCI are also potential solutions because of their capability to limit formation of undesirable constituents.

An important factor in the use of such potential solutions is the ability to control the temperature of the air that enters the engine cylinders for combustion. Diesel engines are today typically turbocharged, and that consideration lends added importance to the control of the temperature of the charge air that a turbocharger creates to impart boost to an engine. When a diesel engine is equipped with a turbocharger, cooling of the charge air is needed when the engine is being operated in certain ways. Hence, the intake system of a turbocharged diesel engine contains some form of heat exchanger disposed between the turbocharger compressor and the engine intake manifold. Today that heat exchanger is frequently referred to as a charge air cooler.

Even in the absence of exhaust emission considerations, the ability to control charge air temperature independently of the engine coolant temperature is an important consideration in engine and vehicle operation.

For many years many large diesel-powered vehicles like heavy trucks and highway tractors have had shutters in front of their engine compartment opening. When the shutters are maximally open, they present minimal restriction to airflow entering the engine compartment through the radiator and charge air cooler. When they are substantially closed, they present maximal restriction to the entering airflow.

Because the radiator of the engine cooling system and the heat exchanger for cooling the charge air are disposed substantially directly behind the shutters when a vehicle is so equipped, shutters have historically served to control the airflow through the radiator and charge air heat exchanger hence controlling engine coolant and charge air temperature.

One form of charge air cooler occupies some of the space in the engine compartment opening that is not occupied by the radiator. When a vehicle that has such a charge air cooler is also equipped with shutters, the opening and closing of the shutters modulates not only the airflow through the radiator, but also the airflow through the charge air cooler. Charge air from the turbocharger is piped to and through the charge air cooler, and then piped to the engine intake manifold. The temperature of the charge air is controlled to some extent by the shutters which, as they open and close, modulate cooling air entering the engine compartment through the front-end engine compartment opening and passing across cooling fins of the charge air cooler.

The shutters are open at various times such as when the cab air conditioning is turned on to allow maximum outside airflow through the air conditioning condenser which is disposed in the engine compartment opening, possibly fully or partially overlapping the radiator. Certain engine coolant temperature conditions also call for the shutters be open. Conditions like these may result in the charge air temperature being less than optimal for best engine operation during such conditions.

The use of shutters for control of charge air temperature is often desired by users of large diesel-powered vehicles because they can improve operating performance. This is borne out by the fact that certain customers continue to order shutters on new trucks. Shutters that cover only the charge air cooler, and not the engine cooling system radiator, have made possible an increase in the average temperature in the interior of a diesel-powered vehicle during cold weather operation. This is especially true in school buses. Further increases in avergae interior temperature would be desirable, particularly if they could be accomplished without the use of shutters.

For various reasons, including regulations that are expected to become effective in the not too distant future, cooling systems of large diesel powered vehicle must have significantly larger cooling capacity. This means that more front end engine compartment space must be allocated to cooling system components. That in turn infringes on space that would be occupied by shutters. Consequently, certain customers of new vehciles are ordering shutters that cover only the charge air cooler portion of the opening. The effectiveness of such shutters however depends on how well they are sealed to the charge air cooler.

For reasons such as these, some existing vehicle design packages may require major front end redesign in order to accommodate the needs of customers who desire shutters. That involves outlays not just for design services, but also for new tooling of various parts, and the costs incurred will have to be passed on, at least in part, to customers through price increases, an undesirable consequence in a competitive marketplace.

### SUMMARY OF THE INVENTION

The present invention is directed toward a novel system and method for enabling charge air temperature to be controlled without the use of shutters, thereby avoiding not only the cost of the shutters but also the need for major front-end redesign in existing vehicles. This will continue to make the benefit of charge air temperature control available to customers who want it, but without incurring the expense of shutters just for that purpose.

The invention can be readily adapted to the requirements of virtually any engine and vehicle model combination to obtain the added performance benefits to charge air temperature control heretofore attempted by using shutters.

Briefly, the invention is embodied by providing a bypass around the charge air cooler and a control system for apportioning the amounts of charge air passing through the bypass and the charge air cooler.

The disclosed control system comprises a valve, preferably a deflector valve having a deflector that is selectively positioned to control the relative amounts of air through the charge air cooler and the bypass, for blending some amount of uncooled charge air that has passed through the bypass with some amount of charge air that has been cooled by virtue of having passed through the charge air cooler. The relative amounts blended to form the charge air entering an engine intake manifold may span large ranges. At one extreme, essentially 0% uncooled air and 100% cooled air, and at the opposite extreme, 100% uncooled air and 0% cooled air.

The invention provides improved temperature control in various ways. Unlike the effect of opening the shutters, the invention allows the charge air temperature entering the engine combustion chambers to remain substantially unaffected by operation of the air conditioning system. Temperature can be optimized for prevailing engine operating conditions largely independent of the cooling load imposed on the radiator. At cold-start, temperature can be controlled to provide faster engine warm-up. The ability to better control temperature provides benefits for engine and vehicle performance and for exhaust after-treatment control.

Specific implementations of the invention may be made in various ways. The bypass can be packaged with the charge air cooler to facilitate assembly procedures. It can be located remote from the charge air cooler but operatively associated with the charge air cooler by fittings, preferably “Y-fittings”, connecting into pipes leading to and from the charge air cooler. A deflector valve can be incorporated internally of one of the Y-fittings for manufacturing and assembly synergy, and an actuator for operating the valve can be mounted on the exterior of the Y-fitting.

Control is accomplished using certain sensors that may already be available in the base vehicle and engine to provide data to an electronic controller, such as an existing ESC (engine system controller). For example, a thermistor disposed to sense charge air temperture into an engine intake manifold indicates that temperature to the ESC. The ESC comprises an algorithm that processes the temperature data to develop an output for control of the deflector valve via the valve actuator.

The valve actuator may be an air cylinder. Air pressure at an existing air manifold is modulated to the air cylinder by an air solenoid in accordance with the output of the ESC to properly position the deflector valve. A pulse width modulated motor may create a better blend-air effect than an air valve.

Generally speaking, the present invention relates to engines, to their intake systems, and to methods involving control of charge air temperature.

One generic aspect of the present invention relates to a motor vehicle comprising an internal combustion engine, a drivetrain, and wheels for propelling the vehicle on land, an intake system for creating charge air and delivering the charge air to an engine intake manifold comprising a charge air cooler, a bypass around the charge air cooler, and a control system for apportioning the charge air flow through the charge air cooler and the bypass.

Another generic aspect of the invention relates to an internal combustion engine comprising an air intake system including a turbocharger for creating and delivering charge air to engine combustion chambers, wherein the air intake system further comprises a charge air cooler for cooling charge air created by the turbocharger before the charge air enters the combustion chambers, a bypass for shunting charge air from the turbocharger around the charge air cooler, and a control system for apportioning the charge air flow through the charge air cooler and the bypass.

Still another generic aspect of the invention relates to a method for controlling charge air cooling in an internal combustion engine having an air intake system including a turbocharger for creating and delivering charge air to engine combustion chambers wherein the air intake system further comprises a charge air cooler for cooling charge air created by the turbocharger before the charge air enters the combustion chambers. The method comprises shunting charge air from the turbocharger through a bypass around the charge air cooler, and apportioning the charge air flow through the charge air cooler and the bypass.

The foregoing, along with further features and advantages of the invention, will be seen in the following disclosure of a presently preferred embodiment of the invention depicting the best mode contemplated at this time for carrying out the invention. This specification includes drawings, now briefly described as follows.

### BRIEF DESCRIPTION OF THE DRAWINGS

FIG. 1 is a perspective view of a portion of the contents of an engine compartment in a large motor vehicle, such as a heavy truck, relevant to an explanation of principles of the invention.

FIG. 2 is an enlarged view in circle 2 in FIG. 1.

FIG. 3 is an enlarged view in circle 3 in FIG. 1 with a portion broken away for illustrative purposes.

FIG. 4 is a schematic diagram relevant to certain principles of the invention.

### DETAILED DESCRIPTION OF THE PREFERRED EMBODIMENT

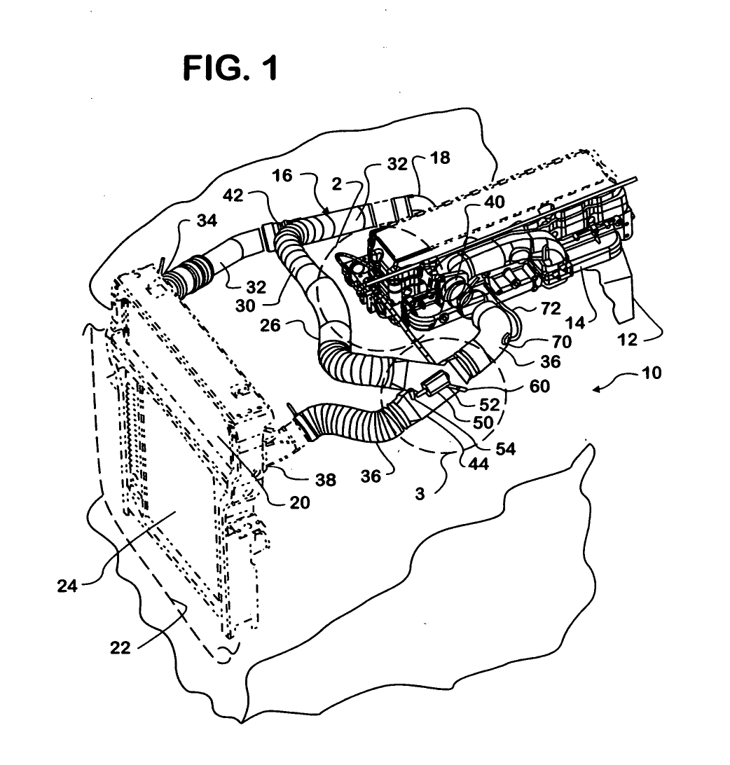

FIG. 1 shows contents of an engine compartment 10 of a heavy truck comprising a diesel engine 12 having an intake manifold 14 that is part of an air intake system 16. Additional components of air intake system 16 include a turbocharger 18 and a charge air cooler 20.

Turbocharger 18 is conventional and comprises a compressor operated by engine exhaust to draw ambient air into the intake system and create charge air that provides boost for engine 12. For removing at least some of the heat of compression from the charge air, the charge air can pass through charge air cooler 20 before it is delivered to intake manifold 14. Charge air cooler 20 is an air-to-air type heat exchanger, meaning one that utilizes air that passes through an air intake opening 22 into engine compartment 10 at the front of the truck to cool the charge air. A radiator 24 that cools engine coolant is also disposed in a portion of the engine compartment opening not occupied by charge air cooler 20. An air conditioning condenser (not shown) may also be present at opening 22 in front of the radiator 24 for cooling refrigerant in the air conditioning system. Certain customers may order new vehicles equipped with shutters that are only over the charge air cooler 20 because they believe that shutters over the radiator make little or no difference in helping the engine produce more heat on cold days. With the present invention, shutters over the charge air cooler become unnecessary, and that is the preferred configuration when the present invention is practiced.

In accordance with principles of the invention, a bypass 26 is provided around charge air cooler 20, and a control system 28 (to be described with reference to FIG. 4) serves to apportion the charge air flow through charge air cooler 20 and bypass 26.

Bypass 26 comprises a conduit 30 disposed within engine compartment 10 rearward of charge air cooler 20. A supply conduit 32 serves to supply charge air from turbocharger 18 to an inlet 34 of charge air cooler 20. A delivery conduit 36 serves to deliver charge air from an outlet 38 of charge air cooler 20 to intake manifold 14, fitting to an inlet 40 of manifold 14.

An inlet fitting 42 provides for an inlet of bypass conduit 30 to have communication with supply conduit 32. An outlet fitting 44 provides for an outlet of bypass conduit 30 to have communication with delivery conduit 36.

Each fitting 42, 44 is preferably a Y-type fitting, meaning that it has two ports arranged at an acute angle with the flows through these two ports being in the same direction. In the case of fitting 42, the two flows are out of the fitting while in the case of fitting 44, they are into the fitting.

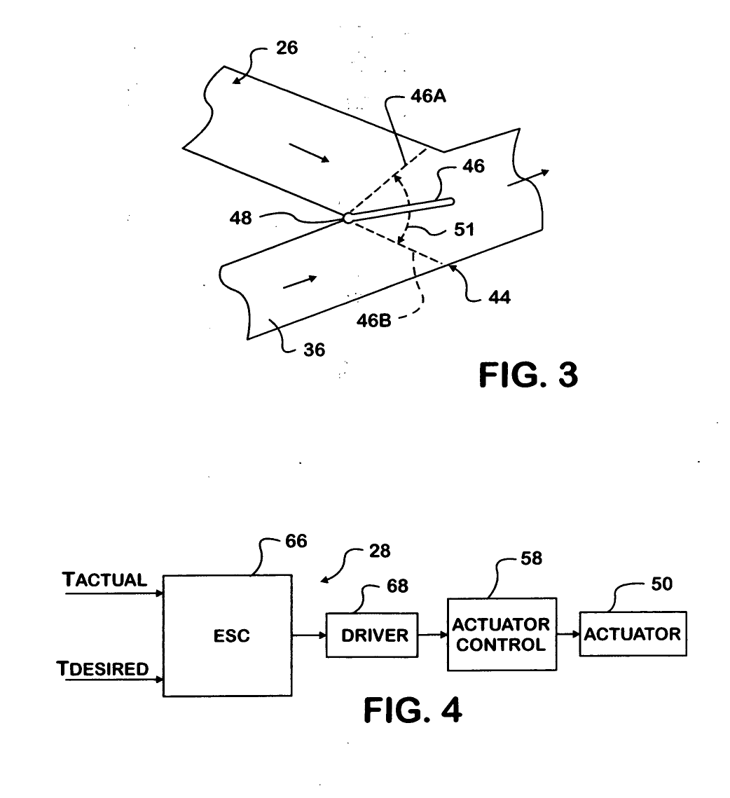

FIG. 3 shows a control element 46 disposed within fitting 44 to comprise a diverter that can swing about an axis 48. As portrayed by FIG. 3, the diverter can swing over a range 51 of positions between a position 46A at least partially restricting flow from bypass conduit 30 and a position 46B at least partially restricting flow from charge air cooler 20. Position 46A actually shows substantially complete obturation of the bypass while position 46B shows substantially complete obturation of flow from charge air cooler 20. In the medial position (solid line) neither incoming flow is significantly obstructed by the diverter.

The diverter is selectively positioned over the range of swinging between positions 46A and 46B by an actuator 50 that is disposed on the exterior of fitting 44 and secured by any suitable means. Actuator 50 is a pulse width modulated electric motor providing movement of control element 46 in incremental steps to provide a blend air effect, or actuator 50 is as shown in the drawings an air cylinder whose linearly movable element is spring-biased in one direction. When air pressure is applied to an inlet port 52 of actuator 50, the linearly movable element is displaced against the spring bias in an amount correlated with the applied air pressure. The movable element acts on a crank arm 54 that is externally attached to a shaft that extends into the inside of the fitting to turn the diverter. Consequently, the diverter is swung about axis 48 to an extent correlated with the air pressure applied to the actuator.

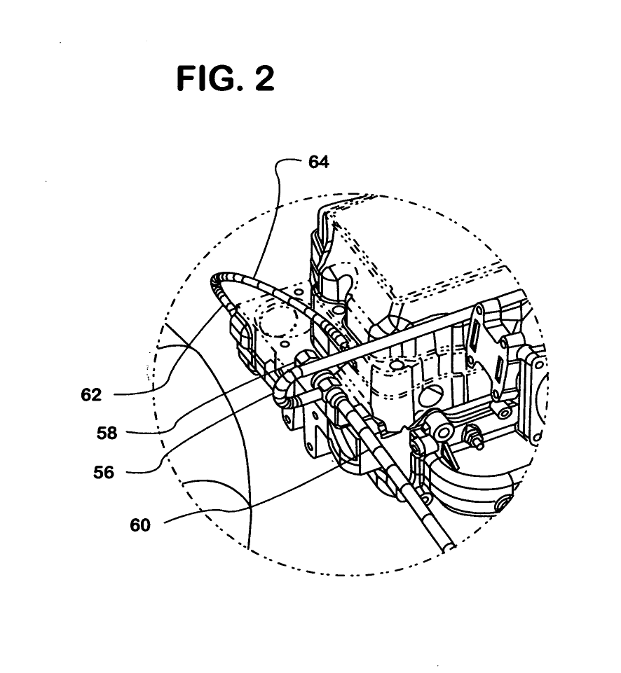

FIG. 2 shows that air pressure for operating actuator 50 is obtained from a pressure source 56, as modulated by an air solenoid 58. The modulated air pressure to actuator 50 is supplied through a conduit 60. While engine coolant temperature may not be used for control of the diverter, engine coolant temperature data as measured by a sensor 62 is transmitted through a connection 64 to an engine control system (ESC) module 66 of system 28 as shown in FIG. 4. Also, inlet air temperature as measured by a thermistor 70 in the delivery conduit 36 downstream of the diverter is transmitted through a connection 72 to the engine system controller (ESC) module 66. ESC module 66 controls actuator 50 through a driver 68 that delivers current to actuator control 58, which is the air solenoid when the actuator is an air cylinder. When the actuator is an electric motor, the driver delivers pulse width modulated current to the motor.

When engine charge air inlet temperature, as sensed by thermistor 70, is below a certain temperature, such as 180° F. for example, all the charge air could be conveyed through the bypass. When engine charge air inlet temperature is above a certain temperature, such as 185° F. for example, all the charge air could be conveyed through the charge air cooler.

With control being provided by ESC module 66, the temperature settings can be adjusted by suitable programming of ESC module 66 for regions or customer preference.

The inventive system can provide faster engine warm-ups and accurately control temperature of charge air entering the engine, thus providing improved performance and emissions control over the use of shutters. The system will cycle to help maintain the engine charge air inlet temperature within the above range of 180° F.-185° F. or a range for optimum engine performance.

While a presently preferred embodiment of the invention has been illustrated and described, it should be appreciated that principles of the invention apply to all embodiments falling within the scope of the following claims.

What is claimed is:

1. A motor vehicle comprising:
an internal combustion engine, a drivetrain, and wheels for propelling the vehicle on land;
an intake system for creating charge air and delivering the charge air to an engine intake manifold comprising a charge air cooler, a bypass around the charge air cooler, and a control system for apportioning the charge air flow through the charge air cooler and the bypass.

2. A motor vehicle as set forth in claim 1 wherein the vehicle comprises an engine compartment containing the engine, an engine compartment opening at a front end of the engine compartment, and the charge air cooler is disposed to be cooled by air entering the engine compartment through the engine compartment opening.

3. A motor vehicle as set forth in claim 2 wherein the bypass comprises a bypass conduit disposed within the engine compartment rearward of the charge air cooler.

4. A motor vehicle as set forth in claim 3 including a turbocharger for creating charge air, a supply conduit for supplying charge air from the turbocharger to an inlet of the charge air cooler, a delivery conduit for delivering charge air from an outlet of the charge air cooler to the engine intake manifold, an inlet fitting through which an inlet of the bypass conduit has communication with the supply conduit, and an outlet fitting through which an outlet of the bypass conduit has communication with the delivery conduit.

5. A motor vehicle as set forth in claim 4 wherein the control system comprises a control element disposed within one of the fittings.

6. A motor vehicle as set forth in claim 5 wherein the control element is disposed within the outlet fitting.

7. A motor vehicle as set forth in claim 5 wherein the one fitting comprises a Y-type fitting and the control element comprises a diverter that can swing over a range of positions between a position substantially restricting flow from the bypass conduit and a position substantially restricting flow from the charge air cooler.

8. A motor vehicle as set forth in claim 7 including an actuator disposed on the exterior of the one fitting for swinging the diverter within the range of positions.

9. A motor vehicle as set forth in claim 1 wherein the bypass and the charge air cooler comprise respective inlet ports through which charge air can enter each and respective outlet ports through which charge air can exit each, and the control system comprises a control element for restricting flow passing through at least one of the ports.

10. A motor vehicle as set forth in claim 9 wherein the control element comprises a diverter that can operate over a range of positions between a position substantially restricting flow from the bypass outlet port and a position substantially restricting flow from the charge air cooler outlet port.

11. A motor vehicle as set forth in claim 9 wherein the diverter is arranged within the interior of a Y-fitting to swing over the range of positions, the Y-fitting has two entrance passageways arranged at an acute angle to each other through one of which passageways flow from the bypass outlet port enters the Y-fitting and through the other of which passageways flow from the charge air cooler outlet port enters the Y-fitting, and an exit passageway through which flow exits the Y-fitting, and further including an actuator for swinging the diverter disposed on the exterior of the Y-fitting.

12. A motor vehicle as set forth in claim 1 wherein the control system comprises a controller that processes data that includes temperature of charge air entering the intake manifold and a desired temperature for that charge air, and that develops control data that controls the apportioning so as to regulate the temperature of charge air entering the intake manifold to the desired temperature.

13. An internal combustion engine comprising:
an air intake system including a turbocharger for creating and delivering charge air to engine combustion chambers wherein the air intake system further comprises a charge air cooler for cooling charge air created by the turbocharger before the charge air enters the combustion chambers, a bypass for shunting charge air from the turbocharger around the charge air cooler, and a control system for apportioning the charge air flow through the charge air cooler and the bypass.

14. An internal combustion engine as set forth in claim 13 wherein the charge air cooler is disposed for cooling charge air by heat transfer from charge air to ambient air.

15. An internal combustion engine as set forth in claim 13 comprising a supply conduit for supplying charge air from the turbocharger to an inlet of the charge air cooler, a delivery conduit for delivering charge air from an outlet of the charge air cooler, an inlet fitting through which an inlet of the bypass has communication with the supply conduit, and an outlet fitting through which an outlet of the bypass has communication with the delivery conduit, and wherein the control system comprises a control element disposed within one of the fittings.

16. An internal combustion engine as set forth in claim 13 wherein the control system comprises a diverter arranged within the interior of a Y-fitting to swing over a range of positions to apportion the charge air flow, the Y-fitting comprises two entrance passageways arranged at an acute angle to each other through which flows enter the Y-fitting and an exit passageway through which flow exits the Y-fitting, and the control system includes an actuator disposed on the exterior of the Y-fitting for swinging the diverter.

17. An engine as set forth in claim 13 wherein the control system comprises a controller that processes data that includes temperature of charge air entering an engine manifold and a desired temperature for that charge air, and that develops control data that controls the apportioning so as to regulate the temperature of charge air entering the intake manifold to the desired temperature.

18. A method for controlling charge air cooling in an internal combustion engine having an air intake system including a turbocharger for creating and delivering charge air to engine combustion chambers wherein the air intake system further comprises a charge air cooler for cooling charge air created by the turbocharger before the charge air enters the combustion chambers, the method comprising
shunting charge air from the turbocharger through a bypass around the charge air cooler, and apportioning the charge air flow through the charge air cooler and the bypass.

19. A method as set forth in claim 18 wherein the step of apportioning the charge air flow comprises selectively positioning a diverter in the air intake system.

20. A method as set forth in claim 18 including sensing temperature of charge air entering an engine manifold and a desired temperature for that charge air, developing control data that controls the apportioning, and using the control data to regulate the temperature of charge air entering the intake manifold to the desired temperature.
